(19) United States
(12) Patent Application Publication
(10) Pub. No.: US 2007/0204028 A1
(43) Pub. Date: Aug. 30, 2007

(54) Method of maximizing the information access rate from/to storage units in wired/wireless networks

(76) Inventor: Hyun Lee, Ladera Ranch, CA (US)

Correspondence Address: Hyun Lee, 21 Thalia St, Ladera Ranch, CA, 92694, US

(21) Appl. No.: 11/646,937

(22) Filed: Dec. 28, 2006

Related U.S. Application Data
(60) Provisional application No. 60/776,762, filed on Feb. 24, 2006.

(51) Int. Cl. G06F 15/173

(52) U.S. Cl. 709/223

(57) ABSTRACT

This invention presents a method of constructing a storage network system that generates and stores information at the adoptive rate that matches the wired/wireless network data transfer rate, and automatically recovers lost data due to physical/functional failure of storages. This storage network system parses data and distributes parallelly to multiple storages for the purpose of reducing the storage access time. The amount of the storage access time reduction is inversely proportion to the number of storages that are accessed simultaneously.

This proposed storage network system also recovers lost data by utilizing the error correction information in the parsed data.

### RELATED APPLICATIONS

The present application is a continuation application of U.S. provisional patent application, Ser. No. US60/776,762, filed Feb. 24, 2006, included by reference herein and for which benefit of the priority date is hereby claimed.

### FIELD OF THE INVENTION

The present invention relates to the field of the wired/wireless networks where the instantaneous data transfer rate can vary without any prior notice, and, more particularly, to the field of Distributed Storage, Distributed Processing, and Parallel Processing.

### BACKGROUND OF THE INVENTION

Any network has bottlenecks that limit the overall performance, and this bottleneck is usually associated with storage access, and the interface between the Physical layer and the Data Link layer. Therefore, although the latest networking technology enables the data transfer between wireless channels with a multiple giga bytes per second rate, the overall system performance would be limited by the storage access time. When the particular storage holds the majority of data that a number of devices in the network system need to access simultaneously, the system overall performance degrades even more.

One other deficiency of the current storage system is that it would require back-up files to restore any corrupted or lost data. The file backup/restoration task usually requires some technical knowledge that a general homeowner lacks.

Currently, to improve the overall data transfer rate, network developers have put their efforts in reducing the storage access time, and the data transfer time between the storage units and the physical layer interface unit. This resulted in introducing fast I/O storage units, such as SATA Hard Drive, that reached the peak data rate of 300 MBps (or 2.4 Giga bits per second).

In addition, the storage manufactures produce simple backup devices, such as CDROM and external hard drive to ease the file backup/restoration task for the general users. However, these devices are mainly to backup PC data, and currently there is no general method that would allow a homeowner to backup the files stored in various devices in a home.

The general shortcoming of the current network developers' solutions is that these solutions do not resolve the basic disparity between the storage access rate and data transfer rate of the physical medium (channels). This is because the average data access rate of the SATA Hard Drive is less than ½, actually close to ⅓, of the peak data access rate due to the burstiness of the storage access pattern, which is caused by the physical/logical partition of the data sectors, the size of the caches, and the overhead in the storage access protocol including the additional seek time. The seek time becomes a dominating factor if a system executes a multiple read operations from a single storage. Furthermore, since there are other physical limitations that associate with various mechanical components in the storage units, the access rate cannot improve indefinitely.

It is therefore an object of the invention to create a wireless network that sustains the maximum data generation and consumption rate that matches the overall data transfer rate of the network

It is another object of the invention to create a wireless network whose data generation and consumption rate that are not degraded by the slowest storage device.

It is another object of the invention to create a wireless network that reduces/minimizes/annihilates the network system performance degradation due to the bottleneck on the storage access by partitioning a complete set of data into a multiple sections, and then distributing these sections into different storages/memories

It is another object of the invention to create a wireless network system that can recover the data that were lost due to physical/logical failures.

It is therefore an object of the invention to create a wireless network system that can recover last updated data that were lost due to physical/logical failures.

### SUMMARY OF THE INVENTION

In accordance with the present invention, there is provided a method of achieving the optimum data generation and consumption rate that would match the data transfer rate of the network system, and a method of constructing a storage network system that automatically recovers lost data due to physical/functional storage failures.

This invention also presents a way of constructing a storage network system that parses data and distributes parallel to multiple storages for the purpose of reducing the storage access time.

The amount of the storage access time reduction is inversely proportional to the number of storages that are accessed simultaneously.

Furthermore, this proposed storage network system recovers lost data by utilizing the error correction information in the parsed data.

When the data is parallelly retrieved from multiple storages, the storage network system reconstructs the original data by assembling the parsed data followed by performing an error correction task, which recovers any lost parsed data due to storage failures.

The amount of lost parsed data that the system recovers is dependent on the amount of error recovery redundancy in the parsed data.

After the storage network system recovers the lost date, it informs the user about the failed storage units, which the user can replace or remove later.

Thus, unlike the traditional backup system that may hold stale data, since this storage network system recovers the lost data that is the last written data, there would be no loss of information.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a detail view of a partition and distribution (p&d) processor block where the data is parsed and parallelly distributed to multiple storage units;

FIG. 2 is a detail view of a wireless connection for the partition and distributing (p&d) processor for both storing and retrieving data;

FIG. 3 is a detail view of the normalized access time of each storage unit that the partition and distribution (p&d) processor may access. This table is referred as the storage capability table (sct); and

FIG. 4 is a detail view of a storage mapping table (smt), which contains information on how the data have been partitioned and distributed.

For purposes of clarity and brevity, like elements and components will bear the same designations and numbering throughout the Figures.

### DESCRIPTION OF THE PREFERRED EMBODIMENT

When the data generation rate and the consumption rate of network devices match the communication channel data transfer rate in the network, the overall performance of the network should be able to achieve the optimal point.

However, in many cases, even when the data generation rate matches with the data transfer rate in the network, the optimum performance level would not be achievable unless the system can coordinate the activities of the data to transmitters and the receivers, the availability the communication channels, and the accessibility of the data storage units.

The recent development in the wired/wireless PHY technologies (such as HDMI, UWB, 802.11n) enables transfer of data from 10 Mbps to near 5 Gbps, and any network that contains devices with these variety of PHY technologies needs to support the data generation and consumption rates that is comparable to the channel bandwidth to achieve the optimal performance. The data generation and consumption rates depend on the end devices that provide visual/audio/data display 201 units, or storage units. Since the visual/audio/data display 201 units are output only devices that usually perform a single function, the data consumption rate is fixed. However, storage units need to support the variable data access rate that matches not only the consumption/generation rate of the end units, but also the data transfer rate of the physical channels.

Previously, the distributed storage or the distributed memory indicates a way of storing information such that a complete set of information is stored in a single physical unit that may also hold multiple sets of complete information. The distributed storage/memory also means that a file server has the table that maps where data/information/software are stored in which storage.

Therefore, all information retrieve requires the file server to behave as the gatekeeper while the information passes through the file server, and the file server becomes the system bottleneck.

This invention presents a method that shows how to construct a network system that dynamically adjusts the overall storage access rate, so that the data access rate matches the data rate required for optimum operation of the visual, audio, and data display 201 units in the network.

This method optimizes the network operation by reducing/minimizing/annihilating the network system performance degradation due to the bottleneck on the storage access by applying the Partition & Distribution (P&D) of data method.

The P&D method simply means to partition a complete set of data into a multiple sections, and distribute these sections into different storages/memories.

There are three advantages of applying this method:

1) When a network looses storage due to a physical/logical failure, the network system can recover the data.

2) Since each storage operates independently, and since there are multiple storages that operate simultaneously, the data generation and consumption rate is computed by:

Max Data generation/consumption rate=S (data rate of each storage unit).

3) Since, the data generation/consumption task is distributed, the computation is also distributed. Therefore, the slowest storage or the slowest file server does not degrade the overall network system performance. In general, the slowest device in the system dictates the worst case system performance. However, the worst case system performance with the P&D method is the average of the performance of all the devices in the network.

The P&D method can be implemented in software, hardware or in both. The important point is the selection of the Partition algorithm. The purpose of partitioning the data is to be able to store the data into many storage elements simultaneously, and to retrieve the data from the same storage elements simultaneously. The Distribution algorithm is based on the access rate and the size of each storage.

The P&D process consists of 4 steps:

Step 1) Error Correction (ex. Reed-Solomon) encoding

Step 2) Byte-wise or Word-wise or Block-wise permutation

Step 3) Byte-wise or Word-wise or Block-wise partition

Step 4) Distribution of the data to multiple storage units

In Step 1:

The data are broken into a manageable size (ex. 64 Bytes), and coded with an error correction code. This coding allows the system to recover the data when storage failures (defects) occur.

In Step 2:

The RS encoded data is permutated as in the following examples. The permutation algorithm needs to match the partition algorithm in Step 3.

In Step 3:

The data partition should be done in such a way that the system could recover the lost data when a storage failure occurs. The system should use two data recovery algorithms: an error correction method or an error erasure method.

The system applies the error correction method for the general error correction when there is burst error due to momentary transfer failures due to noise, interferences, or bad memory sectors in the storage units.

The system applies the error erasure method when the system detects physically failed storage units. Since, when the error locations are known, the error correction capability with the RS error erasure method allows recovery of twice of the data compared to the error correction method, the system would be able to tolerate multiple storage failures without loosing data.

In Step 4:

The system determines the size of the distributed data for each storage unit based on the speed and the capacity of each storage unit so that the access time of all the storage units for storing/retrieving the portion of the distributed data are the same.

To retrieve data, the process works in reverse order that was described in the Partition and Distribution (P&D) steps. The system retrieves data from the storage units in parallel, assembles the data, and executes either the error-correction code and/or the error-erasure code.

This description is an example of how to implement the Partition and Distribution (P&D) function.

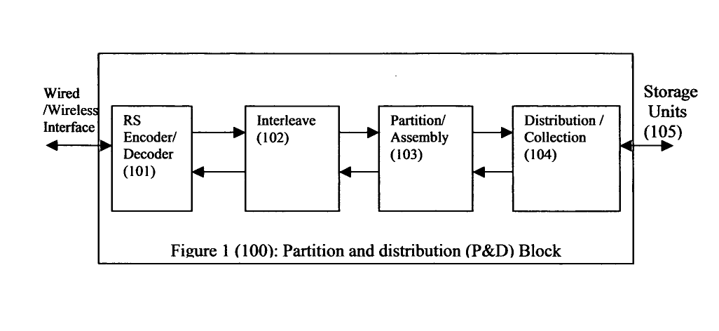

FIG. 1 (100) shows the block diagram of P&D.

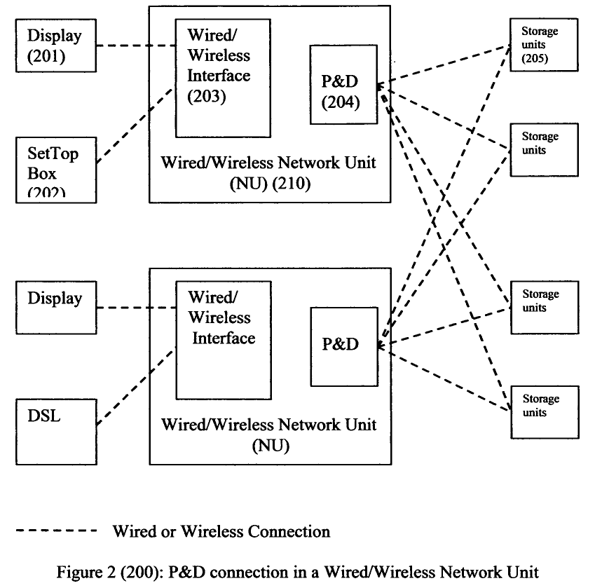

In FIG. 1 (100), the first block (101) is the error-correction block. This block receives or supplies data to the Wired/Wireless Interface block (203) in FIG. 2 (200). The data coming into this block (100) is encoded with an error correcting codes (101). The error-correction encoded data goes into the Byte Interleave (102) to be able to recover data if any storage units experience physical failures.

The byte-interleaved data is partitioned (103) into sections to support high-speed data generation and consumption rate by means of parallel/simultaneous access of multiple Storage Units (105). The partitioned data (103) is distributed by the Distribution (104) according to the discussion presented in the previous section.

The P&D retrieves the data from the multiple Storage Units (105) and processes the data in the reverse order to provide information to the Wired/Wireless Interface block (203). The P&D Collects (104) the data, assembles (103) the data, and conducts the reverse byte interleaving process (102). The RS Encoder/Decode (101) block performs either an error-correction operation or an error-erasure-correction operation on the data it receives from the Byte Interleave (102) block. The system software instructs the RS Encoder/Decoder (101) to perform an error-correction operation when there are no hard failed (physically damaged or unusable) Storage Units (105), or instructs to perform an error-erasure-correction operation if there are any damaged Storage Units (105). This is because the system can inform the RS Encoder/Decoder (101) with the location of errors that are related to the damaged Storage Units, and the RS Encoder/Decoder (101) can double the data recovery efficiency by utilizing the information on which bytes or bits are expected to fail due to hard failures on the Storage Units (105).

FIG. 2 (200) shows the Partition and Distribution (P&D) process for both storing and retrieving data.

In FIG. 2 (200), the Display 201 (201) represents where the data is consumed, and the SetTop-Box (202) represents where the data is generated. The Display 201 (201) may be more than a single unit where total data demand rate over-exceeds the access rate of the fastest storage unit, and also the data generation rate may over-exceed the access rate of the fastest storage unit.

The Wired/Wireless Network Unit 210 (NU) (203) is the gateway to the Storage Units (205). The Storage Units (205) are shared amongst all Network Units (NU) (210), and each NU (210) consists of the Wired/Wireless Interface (203) and P&D (204), and a network system may comprise of multiple Nus (210). The Wired/Wireless Interface (203) functions as a protocol converter that may link between UWB and USB, or 820.11n and 1394 etc.

The P&D holds the Storage Capability Table 300 (SCT) (300) and the Storage Mapping Table 400 (SMT) (400) along with the Partition & Distribution function that is described previously. The SMT (400) contains information on how the data has been partitioned and distributed. The SCT (300) indicates the normalized access time of each storage unit that the P&D (100) may access. Thus the P&D (100) can synchronize the operation of the storage units for the maximum performance.

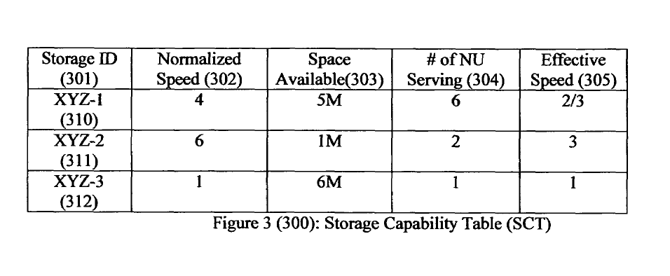

FIG. 3 shows an example of the SCT table (300).

In FIG. 3 (300), the Normalized Speed 302 (302) of XYZ-3 (312) is 1 since XYZ-3 (312) is the slowest storage unit. The Normalized Speed 302 (302) of XYZ-1 (310) is 4, which indicates that the access time of this storage unit is 4 times faster than the XYZ-3 (312). The Normalized Speed 302 (302) for each storage unit stays the same unless the system adds a new storage unit that is slower than the slowest storage unit that was in the system previously.

The Space Available (303) indicates how many Kbytes of memory space has not been used. In this table, XYZ-3 (312) has 6 giga bytes available memory space.

The # of NU Serving (304) indicates how many Wired/Wireless Network Units are connected to the particular storage unit.

The Effective Speed 305 (305) is computed by dividing the Normalized Speed 302 (302) by the # of NU Serving (304).

Effective Speed 305 (305)=Normalized Speed 302 (302)/# of NU Serving (304).

The NU (210) makes the Distribution decision based on this table for the maximum performance, for the NU (210) with this table recognizes that the storage unit XYZ-3 (312) is its own dedicated storage unit with largest available space, but has the slowest access time. However, since this storage unit is not accessed by any other NU (210), the effective speed 305 is faster than the storage unit XYZ-1 (310).

The storage unit XYZ-2 (311) has the fastest Effective Speed 305, but it has the smallest space available. Thus the NU (210) may decide to distribute the majority of its data to XYZ-1 (310) and XYZ-3 (312), and the most timing critical data to XYZ-2 (311). The timing critical data in XYZ-2 (311) may be the first 100 kilo bytes of the information that needs to start the process immediately, and the NU (210) retrieves subsequent information while the Wired/Wireless Interface processes the first 100 kilo bytes of data.

According to SCT Table (300), the effective access time of data is 5/3 of the normalized speed 302 since the storage units XYZ-1 (311) and XYZ-3 (312) are accessed simultaneously.

Therefore, this arrangement supports the network data transfer rate that is 60% faster than the slowest storage unit XYZ-3 (312).

The P&D (100), with the instruction from the software, may increase the SCT (300) and SMT (400) tables to accommodate more storage units to improve the overall storage access speed via simultaneous and parallel operations on more storage units. The P&D (100) optimizes the overall access time by preserving the space in XYZ-2 (312) for the future high-speed access.

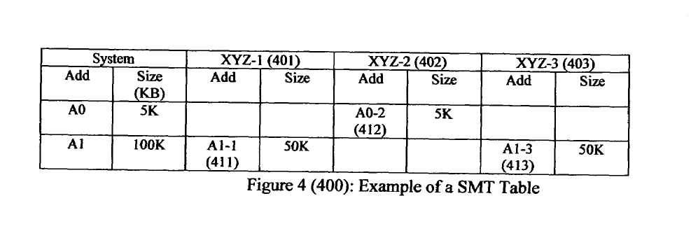

FIG. 4 is an example of the SMT table (400).

In SMT table (400), the system address 401 is the reference address 401 that maps to the physical storage addresses. The total data size is 105 mega bytes, and the first 5 mega bytes are stored in XYZ-2 (402) at address 401 A0-2 (412) for fast access as it was discussed previously. The majority of data is stored in the XYZ-1 (401) and XYZ-3 (403) at the address 401 location A1-1 (411) and A1-3 (413). The 100 mega-byte information may be stored in multiple sectors in each storage units, but the address 401 mapping to the storage unit is handled by the DMA function in the system.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of maximizing the information access rate from/to storage units in wired/wireless networks for maximizing the information access rate from/to the storage units in a wired/wireless network, such that the storage access rate matches the transfer rate in the distributed memory system in the network, comprising:
means for parsing data and distributing simultaneously/parallelly to multiple storages for the purpose of reducing the storage access time;
means for interleaving the encoded data for the purpose of reconstructing data when one or more parsed data contains errors due to storage unit or system failures;
means for parsing the interleaved data into sections to support parallel/simultaneous data storing/retrieving into/from multiple storage units;
means for making software aided decisions on the simultaneous/parallel distribution/collection of the parsed data based on the available spaces and the access time of individual storage units;
means for network system that executes the partition and distribution (p&d) process for both storing and retrieving parsed data with the size that are optimized for each storage unit;
means for gateway to storage units that extracts data from the packets sent by various devices, and prepares the extracted data for the p&d processor;
means for controlling the network storage units for the purpose of guaranteeing the overall storage access rate (both the throughput rate and the latency) to be the same as the data transfer rate of the network system that it is supporting;
means for a table that holds the size and the normalized access time of each storage for the use by the “partition and distribution” element which distributes the parsed data to each storage based on this table to achieve the optimum overall storage access time;
means for indicating the average storage access time as a function of the throughput rate and the latency of each storage unit;
means for indicating the number of network memory control devices that have direct access to each storage unit;
means for indicating that the data distribution is based on the effective storage speed, which is a function of the access time of each storage and the number of devices that establishes direct-independent communication with the storage;
means for indicating that the storage id and the offset address to which the parsed data is distributed;
means for indicating the addresses of the storage elements in the smt table; and
means for indicating the offset address of each storage element where either entire data or a part of data is stored.

2. The method of maximizing the information access rate from/to storage units in wired/wireless networks in accordance with claim 1, wherein said means for parsing data and distributing simultaneously/parallelly to multiple storages for the purpose of reducing the storage access time comprises a functional block partition and distribution (p&d) block.

3. The method of maximizing the information access rate from/to storage units in wired/wireless networks in accordance with claim 1, wherein said means for interleaving the encoded data for the purpose of reconstructing data when one or more parsed data contains errors due to storage unit or system failures comprises a functional element word/byte/bit interleave-permutation block.

4. The method of maximizing the information access rate from/to storage units in wired/wireless networks in accordance with claim 1, wherein said means for parsing the interleaved data into sections to support parallel/simultaneous data storing/retrieving into/from multiple storage units comprises a functional block partition/assembly.

5. The method of maximizing the information access rate from/to storage units in wired/wireless networks in accordance with claim 1, wherein said means for making software aided decisions on the simultaneous/parallel distribution/collection of the parsed data based on the available spaces and the access time of individual storage units comprises a functional element distribution/collection.

6. The method of maximizing the information access rate from/to storage units in wired/wireless networks in accordance with claim 1, wherein said means for network system that executes the partition and distribution (p&d) process for both storing and retrieving parsed data with the size that are optimized for each storage unit comprises a functional block partition and distribution (p&d) connection in the wired/wireless network unit.

7. The method of maximizing the information access rate from/to storage units in wired/wireless networks in accordance with claim 1, wherein said means for gateway to storage units that extracts data from the packets sent by various devices, and prepares the extracted data for the p&d processor comprises a functional element wired/wireless interface.

8. The method of maximizing the information access rate from/to storage units in wired/wireless networks in accordance with claim 1, wherein said means for controlling the network storage units for the purpose of guaranteeing the overall storage access rate (both the throughput rate and the latency) to be the same as the data transfer rate of the network system that it is supporting comprises a functional block wired/wireless network unit.

9. The method of maximizing the information access rate from/to storage units in wired/wireless networks in accordance with claim 1, wherein said means for a table that holds the size and the normalized access time of each storage for the use by the “partition and distribution” element which distributes the parsed data to each storage based on this table to achieve the optimum overall storage access time comprises a storage performance table, normalized storage capability table.

10. The method of maximizing the information access rate from/to storage units in wired/wireless networks in accordance with claim 1, wherein said means for indicating the average storage access time as a function of the throughput rate and the latency of each storage unit comprises a table element, normalized access time of storage normalized speed.

11. The method of maximizing the information access rate from/to storage units in wired/wireless networks in accordance with claim 1, wherein said means for indicating the number of network memory control devices that have direct access to each storage unit comprises a table element # of network unit serving.

12. The method of maximizing the information access rate from/to storage units in wired/wireless networks in accordance with claim 1, wherein said means for indicating that the data distribution is based on the effective storage speed, which is a function of the access time of each storage and the number of devices that establishes direct-independent communication with the storage comprises a table element, effective storage speed effective speed.

13. The method of maximizing the information access rate from/to storage units in wired/wireless networks in accordance with claim 1, wherein said means for indicating that the storage id and the offset address to which the parsed data is distributed comprises a table element, storage address mapping storage mapping table.

14. The method of maximizing the information access rate from/to storage units in wired/wireless networks in accordance with claim 1, wherein said means for indicating the addresses of the storage elements in the smt table comprises a storage elements address.

15. The method of maximizing the information access rate from/to storage units in wired/wireless networks in accordance with claim 1, wherein said means for indicating the offset address of each storage element where either entire data or a part of data is stored comprises an off set address offset address.

16. A method of maximizing the information access rate from/to storage units in wired/wireless networks for maximizing the information access rate from/to the storage units in a wired/wireless network, such that the storage access rate matches the transfer rate in the distributed memory system in the network, comprising:
a functional block partition and distribution (p&d) block, for parsing data and distributing simultaneously/parallelly to multiple storages for the purpose of reducing the storage access time;
a functional element word/byte/bit interleave-permutation block, for interleaving the encoded data for the purpose of reconstructing data when one or more parsed data contains errors due to storage unit or system failures;
a functional block partition/assembly, for parsing the interleaved data into sections to support parallel/simultaneous data storing/retrieving into/from multiple storage units;
a functional element distribution/collection, for making software aided decisions on the simultaneous/parallel distribution/collection of the parsed data based on the available spaces and the access time of individual storage units;
a functional block partition and distribution (p&d) connection in the wired/wireless network unit, for network system that executes the partition and distribution (p&d) process for both storing and retrieving parsed data with the size that are optimized for each storage unit;
a functional element wired/wireless interface, for gateway to storage units that extracts data from the packets sent by various devices, and prepares the extracted data for the p&d processor;
a functional block wired/wireless network unit, for controlling the network storage units for the purpose of guaranteeing the overall storage access rate (both the throughput rate and the latency) to be the same as the data transfer rate of the network system that it is supporting;
a storage performance table, normalized storage capability table, for a table that holds the size and the normalized access time of each storage for the use by the “partition and distribution” element which distributes the parsed data to each storage based on this table to achieve the optimum overall storage access time;
a table element, normalized access time of storage normalized speed, for indicating the average storage access time as a function of the throughput rate and the latency of each storage unit;
a table element # of network unit serving, for indicating the number of network memory control devices that have direct access to each storage unit;
a table element, effective storage speed effective speed, for indicating that the data distribution is based on the effective storage speed, which is a function of the access time of each storage and the number of devices that establishes direct-independent communication with the storage;
a table element, storage address mapping storage mapping table, for indicating that the storage id and the offset address to which the parsed data is distributed; a storage elements address, for indicating the addresses of the storage elements in the smt table; and
an off set address offset address, for indicating the offset address of each storage element where either entire data or a part of data is stored.

17. The method of maximizing the information access rate from/to storage units in wired/wireless networks as recited in claim 16, further comprising:
a functional element error correction block, for coding the original data for the purpose of recovering data in the future when a part of parsed data is lost due to system error or storage failures.
